(19) United States
(12) Patent Application Publication
(10) Pub. No.: US 2010/0196071 A1
(43) Pub. Date: Aug. 5, 2010

(54) METHOD OF CONTROLLING AUTOMATIC ELECTROSTATIC MEDIA SHEET PRINTING

(75) Inventors: Daniel W. Costanza, Webster, NY (US); Alex Brougham, Webster, NY (US)

Correspondence Address: FAY SHARPE / XEROX - ROCHESTER, 1228 EUCLID AVENUE, 5TH FLOOR, THE HALLE BUILDING, CLEVELAND, OH, 44115, US

(73) Assignee: XEROX CORPORATION, Norwalk, CT (US)

(21) Appl. No.: 12/764,427

(22) Filed: Apr. 21, 2010

Related U.S. Application Data
(62) Division of application No. 11/787,777, filed on Apr. 18, 2007.

(51) Int. Cl. B41J 11/42

(52) U.S. Cl. 399/394

(57) ABSTRACT

The present disclosure describes a method of automatically controlling feeding and transporting print media sheets through plural electrostatic print engines having seamed photoreceptor belts for duplex printing. In one embodiment the second photoreceptor belt is driven at a variable speed to maintain a constant phase relationship between the respective seams of the belts. The print image magnification on the front side of the printed sheet is matched by varying the speed of the scanner (ROS) in the second engine. In another embodiment. the first and second photoreceptor belts are both driven at a constant speed and the seam phase allowed to float. Sensors provide a timing signal upon passage of the seam in each belt respectively; and, the position of the belt seams thus determined. The system then calculates a release time for each sheet from the feeder to insure the sheet avoids the seam on both belts.

INCORPORATION BY REFERENCE

This is a divisional application of U.S. Ser. No. 11/787,777, filed Apr. 18, 2007, entitled “Method of Controlling Automatic Electrostatic Media Sheet Printing,” by Daniel W. Costanza et al., the disclosure of which is hereby incorporated by reference in its entirety.

### CROSS REFERENCE TO RELATED PATENTS AND APPLICATIONS

The following patents/applications, the disclosures of each being totally incorporated herein by reference are mentioned:

U.S. Pat. No. 6,973,286 (Attorney Docket A2423-US-NP), issued Dec. 6, 2005, entitled “HIGH RATE PRINT MERGING AND FINISHING SYSTEM FOR PARALLEL PRINTING,” by Barry P. Mandel, et al.;

U.S. Application No. US-2006-0012102-A1 (Attorney Docket A0723-US-NP), published Jan. 19, 2006, entitled “FLEXIBLE PAPER PATH USING MULTIDIRECTIONAL PATH MODULES,” by Daniel G. Bobrow;

U.S. Pat. No. 7,206,532 (Attorney Docket A3404-US-NP), Issued Apr. 17, 2007, entitled “MULTIPLE OBJECT SOURCES CONTROLLED AND/OR SELECTED BASED ON A COMMON SENSOR,” by Robert M. Lofthus, et al.;

U.S. Pat. No. 7,924,152 (Attorney Docket A4050-US-NP), issued Apr. 4, 2006, entitled “PRINTING SYSTEM WITH HORIZONTAL HIGHWAY AND SINGLE PASS DUPLEX,” by Robert M. Lofthus, et al.;

U.S. Pat. No. 7,123,873 (Attorney Docket A3190-US-NP), issued Oct. 17, 2006, entitled “PRINTING SYSTEM WITH INVERTER DISPOSED FOR MEDIA VELOCITY BUFFERING AND REGISTRATION,” by Joannes N. M. deJong, et al.;

U.S. application Ser. No. 10/924,458 (Attorney Docket A3548-US-NP), filed Aug. 23, 2004, entitled “PRINT SEQUENCE SCHEDULING FOR RELIABILITY,” by Robert M. Lofthus, et al.; U.S. Pat. No. 6,959,165 (Attorney Docket A2423-US-DIV), issued Oct. 25, 2005, entitled “HIGH RATE PRINT MERGING AND FINISHING SYSTEM FOR PARALLEL PRINTING,” by Barry P. Mandel, et al.;

U.S. Pat. No. 7,162,172 (Attorney Docket 20040314-US-NP), Issued Jan. 9, 2007, entitled “SEMI-AUTOMATIC IMAGE QUALITY ADJUSTMENT FOR MULTIPLE MARKING ENGINE SYSTEMS,” by Robert E. Grace, et al.;

U.S. Publication No. US-2006-0197966-A1 (Attorney Docket 20031659-US-NP), Published Sep. 7, 2006, entitled “GRAY BALANCE FOR A PRINTING SYSTEM OF MULTIPLE MARKING ENGINES,” by R. Enrique Viturro, et al.;

U.S. Publication No. US-2006-0114313-A1 (Attorney Docket 20040448-US-NP), Published Jun. 1, 2006, entitled “PRINTING SYSTEM,” by Steven R. Moore;

U.S. Publication No. US-2006-0209101-A1 (Attorney Docket 20040974-US-NP), Published Sep. 21, 2006, entitled “SYSTEMS AND METHODS FOR MEASURING UNIFORMITY IN IMAGES,” by Howard Mizes;

U.S. Publication No. US-2006-0214364-A1 (Attorney Docket 20040241-US-NP), Published Sep. 28, 2006, entitled “SHEET REGISTRATION WITHIN A MEDIA INVERTER,” by Robert A. Clark, et al.;

U.S. Publication No. 20031468-US-NP (Attorney Docket 20031468-US-NP), Published Sep. 28, 2006, entitled IMAGE QUALITY CONTROL METHOD AND APPARATUS FOR MULTIPLE MARKING ENGINE SYSTEMS,” by Michael C. Mongeon;

U.S. Publication No. US-2006-0222384-A1 (Attorney Docket 20040446-US-NP), Published Oct. 5, 2006, entitled “IMAGE ON PAPER REGISTRATION ALIGNMENT,” by Steven R. Moore, et al.;

U.S. Publication No. US-2006-0227350-A1 (Attorney Docket 20041209-US-NP), Published Oct. 12, 2006, entitled “SYNCHRONIZATION IN A DISTRIBUTED SYSTEM,” by Lara S. Crawford, et al.;

U.S. Publication No. US-2006-0235547-A1 (Attorney Docket 20041214-US-NP), published Oct. 19, 2006, entitled “ON-THE-FLY STATE SYNCHRONIZATION IN A DISTRIBUTED SYSTEM,” by Haitham A. Hindi;

U.S. Publication No. US-2006-0233569-A1 (Attorney Docket 19971059-US-NP), filed Oct. 19, 2006, entitled “SYSTEMS AND METHODS FOR REDUCING IMAGE REGISTRATION ERRORS,” by Michael R. Furst, et al.;

U.S. application Ser. No. 11/109,566 (Attorney Docket 20032019-US-NP), filed Apr. 19, 2005, entitled “MEDIA TRANSPORT SYSTEM,” by Barry P. Mandel, et al.;

U.S. Publication No. US-2006-0238778-A1 (Attorney Docket 20040704-US-NP), Published Oct. 26, 2006, entitled “PRINTING SYSTEMS,” by Michael C. Mongeon, et al.;

U.S. Publication No. US-2006-0244980-A1 (Attorney Docket 20040656-US-NP, Filed Apr. 27, 2005, entitled “IMAGE QUALITY ADJUSTMENT METHOD AND SYSTEM,” by Robert E. Grace; U.S. Publication No. US-2006-0268317-Al (Attorney Docket 20050382-US-NP), Published Nov. 30, 2006, entitled “SCHEDULING SYSTEM:” by Robert M. Lofthus, et al.;

U.S. Publication No. US-2006-0274337-Al (Attorney Docket 200400621-US-NP), Published Dec. 7, 2006, entitled “INTER-SEPARATION DECORRELATOR,” by Edul N. Dalai, et al.;

U.S. Publication No. US-2006-0274334-A1 (Attorney Docket 20041296-US-NP), Published Dec. 7, 2006, entitled “LOW COST ADJUSTMENT METHOD FOR PRINTING SYSTEMS:” by Michael C. Mongeon;

U.S. Publication No. US-2007-0002403-A1 (Attorney Docket 20040983-US-NP), Published Jan. 4, 2007, entitled “METHOD AND SYSTEM FOR PROCESSING SCANNED PATCHES FOR USE IN IMAGING DEVICE CALIBRATION,” by R. Victor Klassen;

U.S. Publication No. US-2007-0002344-A1 (Attorney Docket 20040964-US-NP), Published Jan. 4, 2007, entitled “COLOR CHARACTERIZATION OR CALIBRATION TARGETS WITH NOISE-DEPENDENT PATCH SIZE OR NUMBER,” by R. Victor Klassen;

U.S. Publication No. US-2007-0024894-A1 (Attorney Docket 20041111-US-NP), Published Feb. 1, 2007, entitled “PRINTING SYSTEM,” by Steven R. Moore, et al.;

U.S. Application Publication No. US-2007-0052991-A1 (Attorney Docket 20041220-US-NP), Published Mar. 8, 2007, entitled “METHOD AND SYSTEMS FOR DETERMINING BANDING COMPENSATION PARAMETERS IN PRINTING SYSTEMS,” by Goodman, et al.;

U.S. application Ser. No. 11/274,638 (Attorney Docket 20050689-US-NP), filed Nov. 15, 2005, entitled “GAMUT SELECTION IN MULTI-ENGINE SYSTEMS,” by Wencheng Wu, et al.;

U.S. application Ser. No. 11/287,685 (Attorney Docket 20050363-US-NP), filed Nov. 28, 2005, entitled “ MULTIPLE IOT PPHOTORECEPTOR BELT SEAM SYNCHRONIZATION,” by Kevin M. Carolan;

U.S. application Ser. No. 11/292,163 (Attorney Docket 20050489-US-NP), filed Nov. 30, 2005, entitled “RADIAL MERGE MODULE FOR PRINTING SYSTEM,” by Barry P. Mandel, et al.;

U.S. application Ser. No. 11/314,774 (Attorney Docket 20050137-US-NP), filed Dec. 21, 2005, entitled “METHOD AND APPARATUS FOR MULTIPLE PRINTER CALIBRATION USING COMPROMISE AIM,” by R. Victor Klassen;

U.S. application Ser. No. 11/317,589 (Attorney Docket 20040327-US-NP), filed Dec. 23, 2005, entitled “UNIVERSAL VARIABLE PITCH INTERFACE INTERCONNECTING FIXED PITCH SHEET PROCESSING MACHINES,” by David K. Biegelsen, et al.; and,

U.S. application Ser. No. 11/378,046 (Attorney Docket 20051682-US-NP), filed Mar. 17, 2006, entitled “PAGE SCHEDULING FOR PRINTING ARCHITECTURES”, by Charles D. Rizzolo, et al.

### BACKGROUND

The present disclosure relates to copying and printing on an electrostatic print engine and more particularly relates to duplex printing on media sheets using print engines of the type transferring an image electrostatically from a photoreceptor to print media sheets.

Heretofore, duplex printing in electrostatic photocopier/printers has required printing one side of a media sheet from an image transferred from a first photoreceptor belt followed by inverting the media sheet and printing on the second side of the sheet by transferring an image from a second photoreceptor belt. In order to transfer the media sheet from the first photoreceptor belt to the second photoreceptor belt and avoid the belt seam, it has been necessary to vary the drive speed of one of the belts in order to synchronize the phase relationship of the seams, or the relationship of one belt seam to the other belt seam, during each period of revolution because of the inherent difference in the lengths of the first and second belt. The seam synchronization requires driving the belts at different speeds, and difference in speeds of the photoreceptor belts has resulted in different print magnification on the photoreceptors. This difference in print magnification from one side to the other thus produces variations in registration of the images printed on opposite sides of the media sheets which produces unacceptable print jobs where the media sheets are to be bound as pages of a multiple page document. Furthermore, shrinkage of the media sheet when passed through the fuser after printing on one side in the first print engine has resulted in errors of print magnification and registration. Thus, it has been desired to provide a way or means of automatically controlling the print magnification and registration in duplex printing on media sheets in electrostatic photocopying and printing equipment.

### BRIEF DESCRIPTION

The present disclosure addresses the above described problems in duplex printing on the electrostatic photocopying machines and provides a way or means of adjusting the printing engines to produce the same page image print magnification and accurate front to back registration on the printed sheets in a manner which accommodates variations in the photoreceptor belts and shrinkage of the media sheet in the toner fusing process. In one embodiment of the method of the present disclosure, the seams of the respective photoreceptor belts in the first and second print engine are synchronized in phase relationship by varying the speed of the second photoreceptor belt; and, the print magnification is maintained by varying the speed of the raster optical scanner in the second print engine to provide the same print magnification as produced in the first print engine on the front side of the media sheet. In a second embodiment of the method of the present disclosure, the speed of the first print engine photoreceptor belt is adjusted to provide the desired magnification on the front side of the media sheet; and, the speed of the photoreceptor belt in the second print engine is adjusted to provide the desired print magnification on the back side of the media sheet, irrespective of the phase relationship of the seams in the first and second photoreceptor belt. The timing of the transfer of the sheet from a feeder to the first belt and from the first belt to the second belt is computed in an algorithm and the position of the belt seams is predicted based upon signals provided from belt seam sensors in order that the transfer of the sheet from the feeder to the first photoreceptor belt and from the first belt to the second belt is timed to miss the seam on either belt.

### BRIEF DESCRIPTION OF THE DRAWINGS

FIG. 1 is a pictorial representation of a duplex electrostatic photocopying machine;

FIG. 2 is a flow diagram of one embodiment of the the method of the present disclosure; and

FIG. 3 is a flow diagram of a second embodiment of the method of the present disclosure.

### DETAILED DESCRIPTION

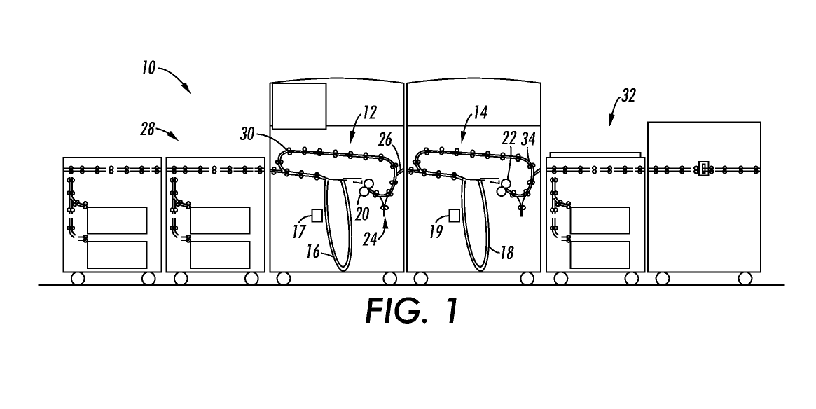

Referring to FIG. 1, a duplex photocopier printer is indicated generally at 10 and includes a first print engine indicated generally at 12 for printing on a front side of a media sheet and a second print engine indicated generally at 14 for effecting printing on the back side of a media sheet in a fully automatically controlled sequence.

The first print engine 12 includes a first photoreceptor belt 16 with accompanying raster output scanner (ROS) (not shown) for imparting an image to be printed on the belt 16; and, the second print engine 14 includes a second photoreceptor belt 18 similarly with accompanying ROS (not shown). Each of the print engines 12, 14 includes a fuser 20, 22 respectively; and, an inverter 24 and transfer devices creating path 26 are provided on the first print engine 12 to position and transport the print media sheet from the first print engine 12 to the second print engine 14.

A supply of sheet media is provided in feeders indicated generally at 28 which supply sheets to transport devices creating path 30 in the first print engine 12. Suitable stackers indicated generally at 32 are operable to receive the completed duplex printed media sheets from a transport device creating a path 34 provided in the second print engine 14.

A pair of sensors 17, 19 are disposed respectively adjacent photoreceptor belts 16, 18 for sensing the passage of the seam of the belt during belt rotation. The sensors are operative to output a timed signal to indicate the relative position of the belt seams with respect to each other at the time each seam passes its respective sensor.

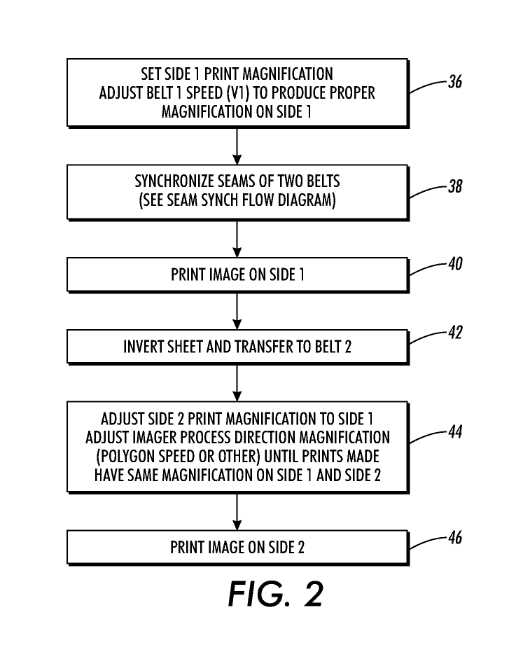

Referring to FIG. 2, the method of a first embodiment of the present disclosure is shown in block flow diagram where at step 36 the system 10 is operable to adjust the speed V1 of first photoreceptor belt 16 to provide the desired magnification of the image to be printed on side one of the print media sheet. The system then proceeds to step 38 and adjusts the speed of the second belt 18 to synchronize the seams of the two belts to a common phase for each belt revolution. When the phase of the two belt seams is synchronized, the system proceeds to print the image on side one of the media sheet in print engine 12; and, after passing through the fuser 20, the sheet is inverted at step 42 by inverter 24 and transferred along path 26 to print engine 14. The system then, at step 44, adjusts the speed of the image processor or ROS in print engine 14 by adjusting the speed of the rotating ROS polygon, or by other suitable means appropriate for the image processor until the print magnification is the same on the front and back sides of the print media sheet. The system then proceeds to step 46 and prints the image on the back or side two of the print media sheet and transfers the printed sheet to the receptacle or stacker 32.

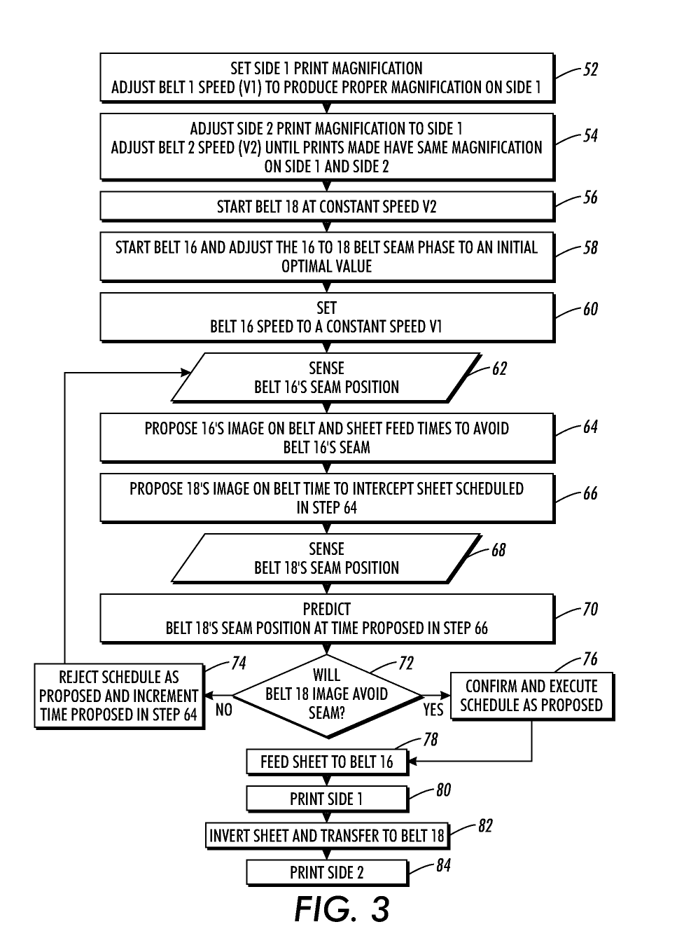

Referring to FIG. 3, another embodiment of the method of the present disclosure is illustrated in block flow diagram form wherein at step 52 the magnification for printing side one of the print media sheet is set by adjusting the speed of the first photoreceptor belt 16 to produce the desired magnification on the front or first side of the print sheet media. The system then proceeds to step 54 and adjusts the speed of the second photoreceptor belt 18 to a speed V2 to yield the same magnification on side two as that of side one of the print media sheet.

The system then proceeds to step 56 and starts the second belt 18 at the predetermined speed V2.

The system then proceeds to step 58 and starts the first belt 16 and adjusts the belt seam phase between belts 16 and 18 to an initial optimal value. The system then proceeds to step 60 and sets the first belt 16 to run at the predetermined speed V1; and, thereafter maintains belt 18 at speed V2 and permits the phase of the belt seams to float with respect to each other.

The system then proceeds to step 62 and senses the passage of the seam of belt seam 16 with sensor 17 and emits a timing signal indicative thereof, to the system controller (not shown) The system then proceeds to step 64 and proposes a time for the sheet to leave the feeder 28 to proceed on transport belt 30 for transport to the belt 16 and avoid the seam of belt 16.

The system then proceeds to step 66 and based upon a known speed and length of transport belt 26, proposes a time for the sheet to arrive at belt 18 in order to miss the seam of belt 18.

The system then proceeds to step 68 and senses the position of the seam of belt 18 with sensor 19 and emits a timing signal indicative thereof to the system controller (not shown).

The system then proceeds to step 70 and predicts the position of belt 18 seam at the time proposed in step 66.

The system then proceeds to step 72 and inquires as to whether the belt 18 image will avoid the seam of belt 18 upon arrival at the time predicted at step 70.

If the inquiry in step 72 is answered in a negative, the system proceeds to step 74 and rejects the scheduled times as proposed and returns to step 62 and increments the time proposed in step 64.

However, if the determination in step 72 is answered in the affirmative, the system proceeds to step 76 and executes the schedule as proposed and proceeds to print the image. The system then proceeds to step 78 and feeds the sheet to belt 16 and at step 80 prints side one of the media sheet. The media sheet is then inverted at step 82 through inverter 24 and fed to print engine 14 and prints side two at step 84.

The embodiment of FIG. 3 thus predicts in advance the time for release of sheets from the feeder 28 and from the belt 16 and then proceeds to release the print media sheet for feeding and transport through the print engines to avoid the seams of both belts without requiring variable driving of the belts to synchronize the phase of the seams.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A method of controlling automatic duplex electrostatic media sheet printing from an imager comprising:
(a) providing a printing engine with a first imager and seamed photoreceptor belt, a second imager and seamed photoreceptor belt and a transport device operable for transporting a print media sheet from the first belt to the second belt;
(b) adjusting the speed (V₁) of the first belt and establishing a desired print magnification on a first side of a media sheet;
(c) printing a first image on a first side of the media sheet;
(d) transporting the media sheet to the second belt with the transport device and adjusting the speed of the second belt and establishing the desired print magnification to the second side of the print media sheet to correspond to the printing on the first side and printing an image on the second side; and,
(e) sensing the relative positions of the belt seams and delaying transfer to the second belt to miss the second seam.

2. The method defined in claim 1, wherein the step of adjusting the imager includes varying the rate of raster optical scanning.

3. The method defined in claim 2, wherein the step of adjusting the imager includes adjusting the rotational speed of the polygon in a raster optical scanner.

4. The method defined in claim 1, wherein the step of transporting the media sheet includes inverting the sheet.

5. A method of control in automatic duplex electrostatic media sheet printing from an imager comprising:
(a) providing a printing engine with an imager, first seamed photoresistor belt, a second seamed photoresistor belt and a transport device for transporting a print media sheet from the first belt to the second belt;
(b) adjusting the speed (V₁) of the first belt to give a desired image magnification on a first side of a media sheet;
(c) adjusting the speed (V₂) of the second belt to give the same image magnification on a second side of the media sheet;
(d) sensing the passage of the seams of the first and second belt and generating a first (S1) and second (S2) seam passage signal;
(e) computing a proposed time to impose an image on and time-to-feed a media sheet onto the first belt based upon S1 to avoid the first belt seam and printing the image on a first side of a sheet;
(f) computing a proposed time to impose an image on and time to transfer the sheet from step (e) to the transfer device based upon S2; and,
(g) transporting the sheet to the second belt and printing an image on a second side of the sheet.

6. The method defined in claim 5, wherein the step of transporting the sheet includes inverting the sheet.
